(19) United States
(12) Patent Application Publication
(10) Pub. No.: US 2026/0008300 A1
(43) Pub. Date: Jan. 8, 2026

(54) BALL DRIVE APPARATUS AND MOBILITY INCLUDING THE SAME

(71) Applicants: Hyundai Motor Company, Seoul (KR); Kia Corporation, Seoul (KR)

(72) Inventor: Danghee Park, Hwaseong-si (KR)

(21) Appl. No.: 18/946,287

(22) Filed: Nov. 13, 2024

(30) Foreign Application Priority Data
Jul. 5, 2024 (KR) 10-2024-0088721

(51) Int. Cl. B60B 19/14; B60K 7/00; B60L 50/60; B60L 53/12

(52) U.S. Cl. CPC B60B 19/14; B60K 7/0007; B60L 50/66; B60L 53/12; B60L 2220/46

(57) ABSTRACT

A ball drive apparatus can be rotatably provided on a body of a mobility to drive the mobility. The ball drive apparatus can include a ball housing formed in a hollow spherical shape, a tire attached to an outer circumferential surface of the ball housing, and a drive unit provided inside the ball housing, wherein the drive unit includes at least one roller that contacts an inner circumferential surface of the ball housing to rotate the ball housing.

### CROSS-REFERENCE TO RELATED APPLICATIONS

This application claims priority to and the benefit of Korean Patent Application No. 10-2024-0088721 filed in the Korean Intellectual Property Office on July 05, 2024, the entire contents of which are incorporated herein by reference.

### TECHNICAL FIELD

The present disclosure relates to a ball drive apparatus and a mobility including the same.

### BACKGROUND

Generally, a mobility travels in a rolling manner using one or more wheels. For the mobility to travel two-dimensionally, a steering device is required that is mounted on a body of the mobility and rotates the wheels about a vertical direction because the wheels are capable of rotating only about axes of the respective wheels. However, due to the structural constraints of the wheels, a suspension, and the steering device, an angle at which the steering device rotates the wheels about the vertical direction is limited. Accordingly, a turning radius of the mobility has been limited, and it has been difficult to achieve special driving such as crab driving, diagonal driving, and 360-degree rotation.

To overcome the shortcomings of conventional mobilities having wheels, ball drive apparatuses have been designed in which ball-shaped wheels rotate so that the mobilities travel. A conventional ball drive apparatus is equipped with a ball drive unit including a plurality of rollers outside a ball. The plurality of rollers is configured to contact an outer circumferential surface of the ball to rotate the ball. However, the conventional ball drive apparatus may occupy a very large volume due to the ball drive unit provided outside the ball, which may reduce the space for users to board or for cargo to be loaded inside the mobility.

The information contained in this background section has been provided to enhance understanding of the background of the present disclosure, and may contain information that does not form the prior art that is already publicly known, available, or in use.

### SUMMARY

The present disclosure relates to a ball drive apparatus and a mobility including the same. More particularly, the present disclosure relates to a ball drive apparatus in which a drive unit for driving a ball is provided inside the ball, and a mobility including the same.

An embodiment of the present disclosure can provide a ball drive apparatus in which a drive unit for driving a ball is provided inside the ball.

An embodiment of the present disclosure can provide a mobility including at least one ball drive apparatus.

An example embodiment of the present disclosure can provide a ball drive apparatus rotatably provided on a body of a mobility to drive the mobility.

The ball drive apparatus can include: a ball housing formed in a hollow spherical shape; a tire attached to an outer circumferential surface of the ball housing; and a drive unit provided inside the ball housing, wherein the drive unit includes at least one roller that contacts an inner circumferential surface of the ball housing to rotate the ball housing.

The at least one roller may include a plurality of rollers, and the plurality of rollers may be arranged so that geometric centers of the plurality of rollers coincide with a center of the ball housing.

The drive unit may further include: an integrated housing including at least one leg extending from the center of the ball housing toward the at least one roller; a steering motor mounted at an end of each leg of the integrated housing, and configured to rotate a motor shaft to which a mounting bracket is connected about the corresponding leg; and a drive motor mounted on the mounting bracket, and configured to rotate a drive motor shaft on which the at least one roller is mounted.

The drive motor shaft may be perpendicular to the motor shaft of the steering motor.

The mobility may include a main battery provided in the body, and a transmission coil electrically connected to the main battery and configured to transmit electric energy of the main battery to the drive unit using a wireless charging method, and the drive unit may further include a reception coil mounted on the integrated housing in proximity to the transmission coil, and receiving the electric energy of the main battery from the transmission coil using a wireless charging method.

The drive unit may further include an auxiliary battery electrically connected to the reception coil, configured to receive the electric energy of the main battery transmitted to the reception coil through the transmission coil, electrically connected to the steering motor and/or the drive motor, and configured to supply the electric energy to the steering motor and/or the drive motor.

The drive unit may further include a controller provided in the integrated housing and configured to control an operation of the drive unit.

The wireless charging method may be one or more methods among a magnetic resonance method, a magnetic induction method, and an electromagnetic wave method, or any combination thereof.

The wireless charging method may be set according to a distance between the transmission coil and the reception coil.

When the distance between the transmission coil and the reception coil is smaller than a first distance, the wireless charging method may be the magnetic induction method, and when the distance between the transmission coil and the reception coil is greater than or equal to the first distance, the wireless charging method may be the magnetic resonance method or the electromagnetic wave method.

The ball drive apparatus may include a plurality of ball pieces, wherein the ball housing and the tire may be manufactured by assembling the plurality of ball pieces, each of the ball pieces may include a protrusion protruding toward another ball piece disposed adjacent to the ball piece with no tire attached to the ball piece, and the protrusion of one ball piece and the protrusion of another adjacent ball piece may be overlapped and joined by a joining member, and then the tire may be attached to the protrusions joined by the joining member.

An example embodiment of the present disclosure can provide a mobility including: a body; and at least one ball drive apparatus rotatably provided on the body. The ball drive apparatus may be the ball drive apparatus according to the example embodiment of the present disclosure.

The drive unit of the ball drive apparatus may further include: an integrated housing including at least one leg extending from a center of the ball housing toward the at least one roller; a steering motor mounted at an end of each leg of the integrated housing, and configured to rotate a motor shaft to which a mounting bracket is connected about the corresponding leg; and a drive motor mounted on the mounting bracket, and configured to rotate a drive motor shaft on which the at least one roller is mounted.

The mobility may further include: a main battery provided in the body; and a transmission coil electrically connected to the main battery and configured to transmit electric energy of the main battery to the drive unit using a wireless charging method, and the drive unit may further include a reception coil mounted on the integrated housing in proximity to the transmission coil, and receiving the electric energy of the main battery from the transmission coil using a wireless charging method.

The wireless charging method may be one or more methods among a magnetic resonance method, a magnetic induction method, and an electromagnetic wave method, or any combination thereof.

The wireless charging method may be set according to a distance between the transmission coil and the reception coil.

When the distance between the transmission coil and the reception coil is smaller than a first distance, the wireless charging method may be the magnetic induction method, and when the distance between the transmission coil and the reception coil is greater than or equal to the first distance, the wireless charging method may be the magnetic resonance method or the electromagnetic wave method.

The drive unit may further include an auxiliary battery electrically connected to the reception coil, configured to receive the electric energy of the main battery transmitted to the reception coil through the transmission coil, electrically connected to the steering motor and/or the drive motor, and configured to supply the electric energy to the steering motor and/or the drive motor.

The mobility may further include a control device provided in the body to control an operation of the mobility, the drive unit may further include a controller provided in the integrated housing and configured to control an operation of the drive unit, and the control device of the mobility and the controller of the drive unit may be connected to each other in a wirelessly communicable manner.

According to an embodiment of the present disclosure, the ball drive apparatus can be modularized to reduce manufacturing and assembling costs.

By reducing the size of the ball drive apparatus, the usable space inside the mobility can be increased, according to an embodiment of the present disclosure.

Special driving such as crab driving, 360-degree rotation, or diagonal driving can be achieved using an embodiment of the present disclosure.

Other advantages that can be obtained or expected from the example embodiments of the present disclosure will be directly or implicitly disclosed in the detailed description of the example embodiments of the present disclosure. That is, various advantages expected according to the example embodiments of the present disclosure will be disclosed in the following detailed description.

### BRIEF DESCRIPTION OF THE DRAWINGS

Example embodiments in the specification may be better understood by referring to the following description in connection with the accompanying drawings in which like reference numerals can refer to identical or functionally similar elements.

FIG. 1 is a schematic view illustrating a mobility having a ball drive apparatus according to an example embodiment of the present disclosure.

FIG. 2 is a schematic view of a ball drive apparatus according to an example embodiment of the present disclosure.

FIG. 3 schematically illustrates an internal structure of a ball drive apparatus according to an example embodiment of the present disclosure.

FIG. 4 is an enlarged view illustrating a partial portion of a drive unit, according to an example embodiment of the present disclosure.

FIG. 5 schematically illustrates how to charge a drive unit, according to an example embodiment of the present disclosure.

FIG. 6 illustrates that a ball drive apparatus according to an example embodiment of the present disclosure travels in a forward direction.

FIG. 7 illustrates that a ball drive apparatus according to an example embodiment of the present disclosure travels in a right direction.

FIG. 8 is a schematic cross-sectional view along the line A-A of FIG. 2 of a ball drive apparatus before being assembled, according to an example embodiment of the present disclosure.

FIG. 9 is a schematic cross-sectional view along the line A-A of FIG. 2 of a ball drive apparatus after being assembled, according to an example embodiment of the present disclosure.

It can be understood that the drawings referenced above are not necessarily drawn to scale and can present a rather simplified representation of various features showing some basic principles of example embodiments of the present disclosure. For example, specific design features of example embodiments of the present disclosure, including a specific dimension, orientation, position, and shape, can be determined in part by the particular intended application and environment of use.

### DETAILED DESCRIPTION OF ILLUSTRATIVE EMBODIMENTS

A term used herein can be only to describe a specific example embodiment and is not intended to necessarily limit the present disclosure. A term of a singular number used herein can be intended to include its plural number unless the context clearly indicates otherwise. It can be understood that the terms "include" and/or "including," when used in the specification, specify the presence of the recited features, integers, steps, operations, elements, and/or components, and they do not exclude the presence or addition of one or more of other features, integers, steps, operations, elements, components, and/or groups thereof. A term "and/or" used herein includes any one or all combinations of the associated listed items.

A "mobility," "of a mobility," or other similar terms used herein may generally include a general land mobility including a passenger vehicle including a sport utility vehicle (SUV), a bus, a truck, a tractor, various commercial vehicles, or the like, a marine mobility including various boats and ships, an aerial mobility including an aircraft, a drone, or the like, and any object that may be moved by receiving power from a power source. The "mobility," "of the mobility," or other similar terms used herein may be understood to include a hybrid mobility, an electric mobility, a plug-in hybrid mobility, a hydrogen-powered mobility, and another alternative fuel (e.g., fuel derived from a source other than petroleum) mobility. As mentioned herein, the hybrid mobility may include a mobility having two or more power sources, for example, a gasoline-powered and electric-powered mobility. The mobility according to embodiments of the present disclosure may include a manually-driven mobility as well as a mobility driven more or less autonomously and/or automatically.

Further, it can be understood that one or more of methods described below or embodiments thereof may be executed by at least one or more controllers. The term "controller" may refer to a hardware device including a memory (or storage medium) and a processor, either or both of which may be in plural or may include plural components thereof. The memory may store program instructions, and the processor may be specifically programmed to execute the program instructions to perform one or more processes described below in more detail. The controller may control operations of units, modules, parts, devices, or a component similar thereto, as described herein. It can be understood that the methods described below may be executed by an apparatus including the controller in conjunction with one or more other components, as appreciated by those skilled in the art.

The controller of embodiments of the present disclosure may be implemented as a non-transitory computer-readable recording medium including executable program instructions executed by the processor. An example of the computer-readable recording medium may include a read only memory (ROM), a random access memory (RAM), a compact disk read only memory (CD-ROM), a magnetic tape, a floppy disk, a flash drive, a smart card, or an optical data storage device, and the present disclosure is not limited thereto. The computer-readable recording medium may also be distributed throughout a computer network, and the program instructions may thus be stored and executed in a distributed manner, for example, on a telematics server or a controller area network (CAN).

Hereinafter, example embodiments of the present disclosure are described in detail with reference to the accompanying drawings.

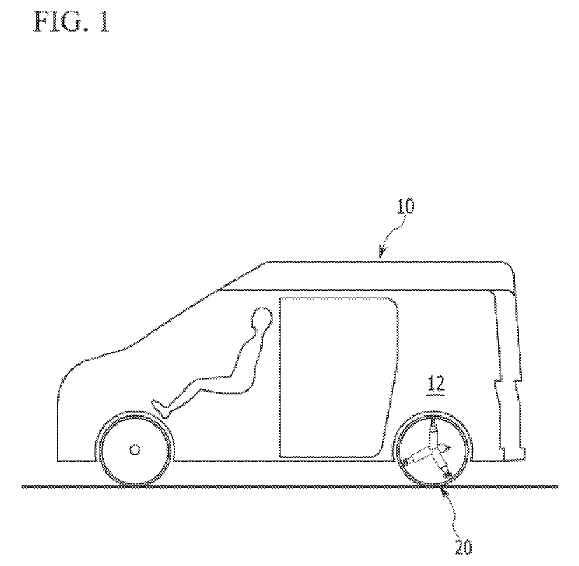

FIG. 1 is a schematic view illustrating a mobility having a ball drive apparatus according to an example embodiment of the present disclosure.

As illustrated in FIG. 1, a mobility 10 includes a body 12, and at least one ball drive apparatus 20 is provided on a bottom surface of the body 12.

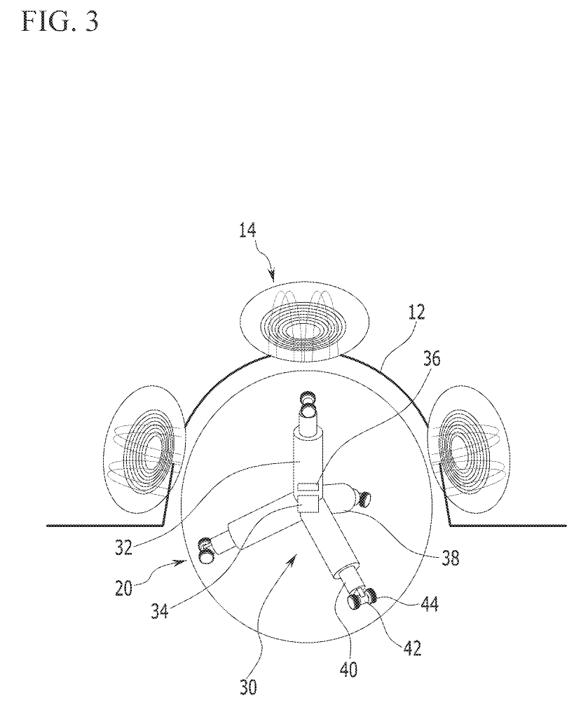

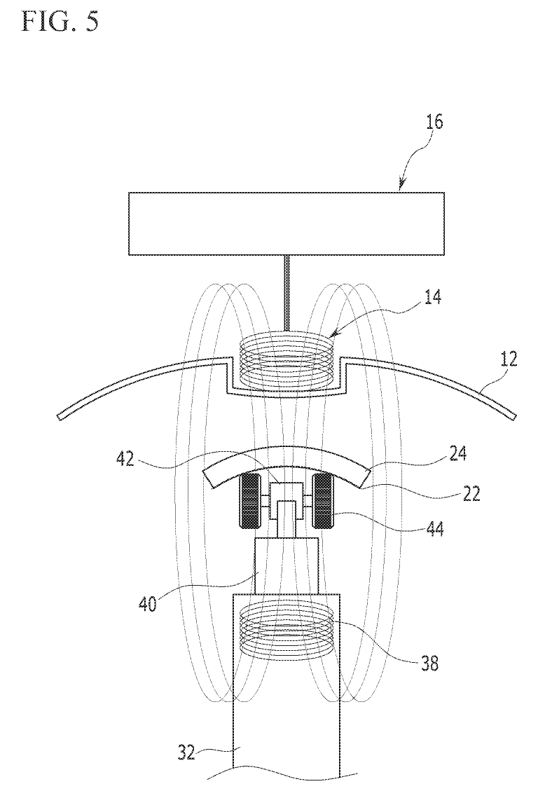

Referring to FIGS. 3 and 5, inside the body 12, a space for people to board or for cargo to be loaded may be formed, or various components for operating the mobility 10 may be installed. For example, a transmission coil 14 and a main battery 16 may be mounted on the body 12. The main battery 16 can store electric energy for driving the mobility 10, and the transmission coil 14 can be electrically connected to the main battery 16 and configured to transmit the electric energy of the main battery 16 to the at least one ball drive apparatus 20. That is, the transmission coil 14 may charge an auxiliary battery 36 (see FIG. 3) inside the at least one ball drive apparatus 20 using the electric energy of the main battery 16, or may directly supply the electric energy of the main battery 16 to the at least one ball drive apparatus 20 using a wireless charging method. For example, the transmission coil 14 may transmit the electric energy of the main battery 16 to the at least one ball drive apparatus 20 using one or more methods among a magnetic resonance method, a magnetic induction method, and an electromagnetic wave method.

The at least one ball drive apparatus 20 can be rotatably provided on the bottom surface of the body 12, and can have a spherical shape. For example, at least one ball seating groove corresponding to the at least one ball drive apparatus 20 can be formed on the bottom surface of the body 12, and each ball drive apparatus 20 may be rotatably seated in the corresponding ball seating groove. In one example, a plurality of relatively small balls can be rotatably mounted on an inner circumferential surface of the ball seating groove, and the ball drive apparatus 20 may contact the plurality of balls and be rotatably supported by the plurality of balls. Accordingly, each ball drive apparatus 20 may rotate in any direction around its own center. By appropriately controlling the at least one ball drive apparatus 20, the mobility 10 may implement special driving, such as crab driving (moving perpendicular to the longitudinal direction of the mobility 10), 360-degree rotation (rotating in place around the center of the mobility 10), and diagonal driving (moving forward or backward at a predetermined angle with respect to the longitudinal direction of the mobility 10).

Hereinabove, one example of the ball drive apparatus 20 that can be rotatably provided on the bottom surface of the body 12 has been described. However, a method of rotatably seating the ball drive apparatus 20 on the bottom surface of the body 12 for an embodiment is not necessarily limited to the above-described example, and various methods currently known to those skilled in the art or later developed may be used.

Hereinafter, the ball drive apparatus 20 according to an example embodiment of the present disclosure will be described in more detail.

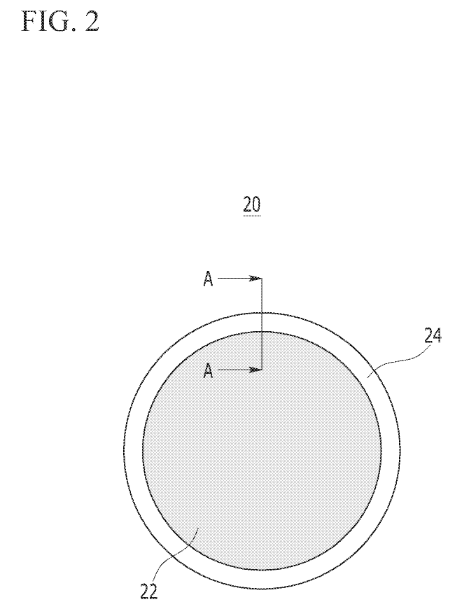

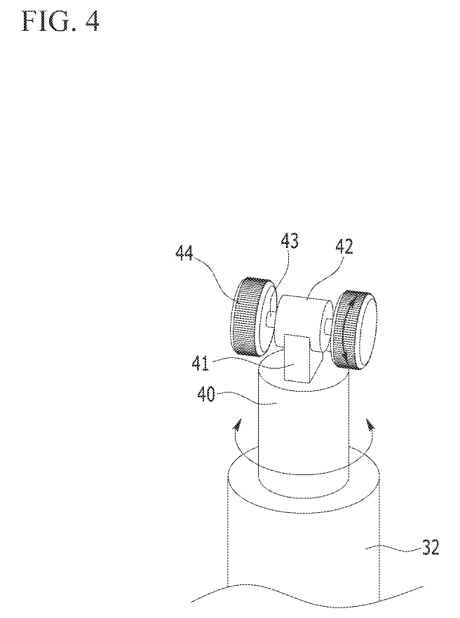

FIG. 2 is a schematic view of a ball drive apparatus according to an example embodiment of the present disclosure. FIG. 3 schematically illustrates an internal structure of a ball drive apparatus according to an example embodiment of the present disclosure. FIG. 4 is an enlarged view illustrating a partial portion of a drive unit. FIG. 5 schematically illustrates how to charge a drive unit.

As illustrated in FIG. 2, the ball drive apparatus 20 can include a ball housing 22 and a tire 24.

The ball housing 22 can be formed in a spherical shape, and made of a metal material or a strong plastic material to protect components provided inside the ball housing 22 from external impacts or the like. The ball housing 22 can form an interior cavity.

The tire 24 can cover an outer circumferential surface of the ball housing 22, and can be attached to the outer circumferential surface of the ball housing 22. The tire 24 may be made of an elastic material such as rubber and/or urethane.

As illustrated in FIGS. 3 to 5, the ball drive apparatus 20 can further include a drive unit 30 provided inside the ball housing 22. The drive unit 30 can include at least one roller 44 that contacts an inner circumferential surface of the ball housing 22 to rotate the ball housing 22. The roller 44 can be in frictional contact with the inner circumferential surface of the ball housing 22 to transmit a driving force. Preferably, the at least one roller 44 includes a plurality of rollers 44, and the plurality of rollers 44 may be arranged such that their geometric centers coincide with the center of the ball housing 22. Accordingly, even though the plurality of rollers 44 rotate the ball housing 22, the plurality of rollers 44 can be kept at fixed positions. Although as an example in FIG. 3 four pairs of rollers 44 are arranged at the four vertices of an equilateral triangular pyramid, respectively, the arrangement of the rollers 44 and the number of rollers 44 are not necessarily limited thereto.

The drive unit 30 can further include an integrated housing 32, a steering motor 40, and a drive motor 42.

The integrated housing 32 can include at least one leg extending from the center of the ball housing 22 toward the at least one roller 44. If the drive unit 30 can include a plurality of rollers 44, the integrated housing 32 can include a plurality of legs extending from the center of the ball housing 22 toward the respective rollers 44 and the plurality of legs can meet each other at the center of the ball housing 22. A controller 34, the auxiliary battery 36, and a reception coil 38 may be provided inside the integrated housing 32.

The controller 34 may be connected to a control device of the mobility 10 in a wirelessly communicable manner, or may be connected to a controller 34 of another ball drive apparatus 20 in a wirelessly communicable manner. The controller 34 may receive a control command from the control device of the mobility 10 or the controller 34 of another ball drive apparatus 20, or control an operation of the drive unit 30 through its own calculation. For example, the operation of the drive unit 30 may include, but is not limited to, operating the drive motor 42 at a target speed and at a target torque, rotating the steering motor 40 at a target angle, and charging the auxiliary battery 36. The controller 34 may store a control algorithm for controlling the operation of the drive unit 30.

The auxiliary battery 36 can be electrically connected to the drive unit 30, for example, the steering motor 40 and/or the drive motor 42, and can be configured to supply the electric energy to the steering motor 40 and/or the drive motor 42. The auxiliary battery 36 can be electrically connected to the reception coil 38, and can be configured to receive the electric energy of the main battery 16 transmitted to the reception coil 38 through the transmission coil 14.

The reception coil 38 can be connected to the transmission coil 14 to receive electric energy using a wireless charging method, and can be electrically connected to the auxiliary battery 36 to transmit the electric energy to the auxiliary battery 36. The transmission coil 14 may be mounted on the body 12, preferably in the ball seating groove, and the reception coil 38 may be mounted in proximity to the corresponding transmission coil 14 inside the integrated housing 32. The reception coil 38 can be magnetically connected to the transmission coil 14, and may receive the electric energy of the main battery 16 from the transmission coil 14 using a wireless charging method under the control of the control device of the mobility 10 or the controller 34.

As described above, the wireless charging method may be one or more methods among the magnetic resonance method, the magnetic induction method, and the electromagnetic wave method, or any combination thereof. The wireless charging method may be set according to a distance between the transmission coil 14 and the reception coil 38. In one example, if the distance between the transmission coil 14 and the reception coil 38 is smaller than a first distance (i.e., if the transmission coil 14 and the reception coil 38 are located close to each other), the wireless charging method may be the magnetic induction method. In another example, if the distance between the transmission coil 14 and the reception coil 38 is greater than or equal to the first distance (i.e., the transmission coil 14 and the reception coil 38 are located far from each other), the wireless charging method may be the magnetic resonance method or the electromagnetic wave method. The first distance may be about 1 m, but is not limited thereto.

The steering motor 40 can be mounted at an end of each leg of the integrated housing 32. A mounting bracket 41 can be mounted on or connected to a motor shaft of the steering motor 40, and the steering motor 40 can rotate the mounting bracket 41 about a direction of the motor shaft.

The drive motor 42 can be mounted on the mounting bracket 41. A drive motor shaft 43 of the drive motor 42 may be disposed perpendicular to the motor shaft of the steering motor 40, and the roller 44 may be mounted at an end of the drive motor shaft 43. The drive motor 42 can rotate the roller 44 via the drive motor shaft 43, and the rotating roller 44 can rotate the ball housing 22 in frictional contact with the inner circumferential surface of the ball housing 22, so that the mobility 10 moves corresponding to a rotational direction of the ball housing 22. In a case where the plurality of rollers 44 are arranged inside the ball housing 22, some of the rollers 44 may be used to drive the ball drive apparatus 20, while the other rollers 44 may be used to maintain a posture of the drive unit 30.

As illustrated in FIG. 4, the drive motor shaft 43 can protrude from both sides of the drive motor 42 and the rollers 44 can be rotatably mounted at both ends of the drive motor shaft 43, respectively, but the structure of the drive motor shaft 43, the number of rollers 44, and the arrangement of the rollers 44 are not necessarily limited thereto.

Hereinafter, an operation of the ball drive apparatus 20 according to an example embodiment of the present disclosure will be described with reference to FIGS. 1 to 7. For example, the drive unit 30 can include four pairs of rollers 44 disposed at the four vertices of the equilateral triangular pyramid, respectively.

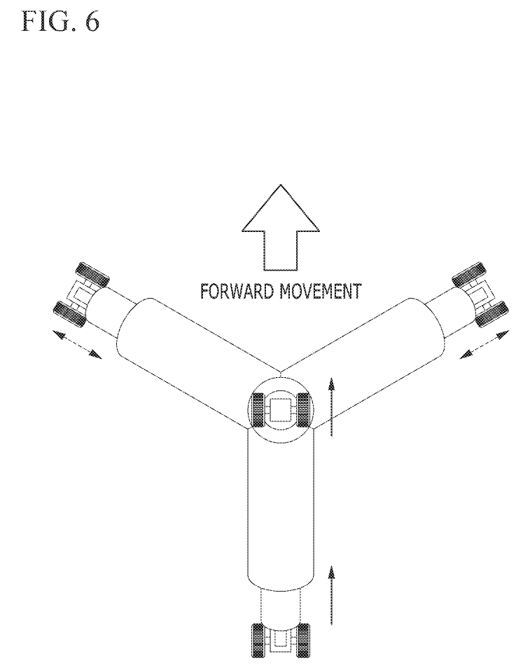

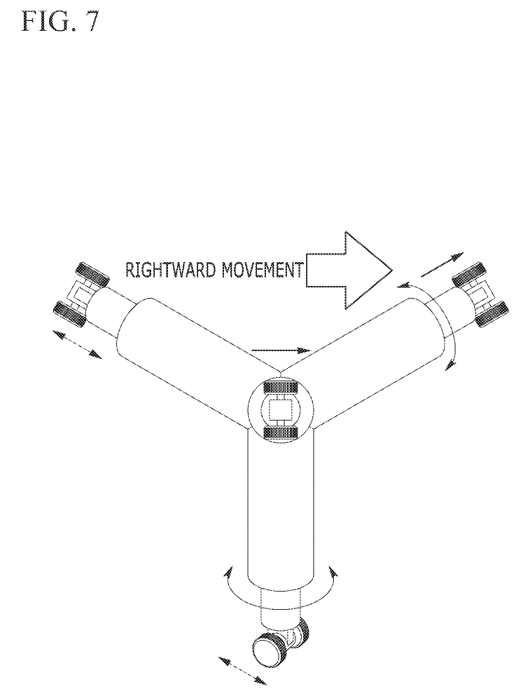

FIG. 6 illustrates that a ball drive apparatus according to an example embodiment of the present disclosure can travel in a forward direction. FIG. 7 illustrates that a ball drive apparatus according to an example embodiment of the present disclosure can travel in a right direction. In FIGS. 6 and 7, solid arrows indicate generation of a driving force and a direction of the driving force, and dotted arrows indicate a force intermittently generated to maintain the posture and a direction of the force.

As illustrated in FIGS. 1 to 5, the mobility 10 can be provided with at least one ball drive apparatus 20 rotatably mounted on the bottom surface of the body 12, and the drive unit 30 can be provided inside the ball housing 22 of each ball drive apparatus 20. The drive unit 30 can include the four pairs of rollers 44 arranged at the four vertices of the equilateral triangular pyramid, respectively, and each pair of rollers 44 can be in frictional contact with the inner circumferential surface of the ball housing 22. The transmission coil 14 can be disposed on the bottom surface of the body 12 in proximity to each of the ball drive apparatus 20.

In this state, as illustrated in FIG. 6, the control device of the mobility 10 or the controller 34 of another ball drive apparatus 20 may receive a control command to move forward or the controller 34 of the ball drive apparatus 20 may determine by itself that the ball drive apparatus 20 is required to move forward. The controller 34 can supply the electric energy of the auxiliary battery 36 or the electric energy of the main battery 16 supplied using a wireless charging method through the transmission coil 14 and the reception coil 38 to the drive motor 42 that drives the rollers 44 aligned with the traveling direction of the ball drive apparatus 20 such that the ball drive apparatus 20 is caused to be moved forward. In this case, the electric energy may not be supplied to the remaining drive motors 42 that drive the remaining rollers 44 that are not aligned with the traveling direction of the ball drive apparatus 20.

If it is predicted that the posture of the drive unit 30 will be changed due to an external impact or for another reason during the operation of the ball drive apparatus 20, the controller 34 can supply the electric energy to some of the drive motors 42 that drive at least some of the remaining rollers 44 to maintain the posture of the drive unit 30. At such time, the controller 34 may control the electric energy supplied to some of the drive motors 42 so that the resultant force of force components acting in a direction perpendicular to the traveling direction of the ball drive apparatus 20 becomes zero.

As illustrated in FIG. 7, the control device of the mobility 10 or the controller 34 of another ball drive apparatus 20 may receive the control command to move rightward, or the controller 34 of the ball drive apparatus 20 may determine by itself that it is required to move rightward. The controller 34 can supply the electric energy to the steering motor 40 including the rollers 44 that can be aligned with the traveling direction of the ball drive apparatus 20 to align the rollers 44 with the traveling direction of the ball drive apparatus 20, and supplies the electric energy to the drive motors 42 that drive the aligned rollers 44 to move the ball drive apparatus 20 rightward. If necessary, the controller 34 may supply the electric energy to some of the steering motors 40 and some of the drive motors 42 including at least some of the remaining rollers 44, so that the resultant force of the force components acting in the direction perpendicular to the traveling direction of the ball drive apparatus 20 becomes zero. If it is predicted that the posture of the drive unit 30 will be changed, the controller 34 may supply the electric energy to some of the steering motors 40 and some of the drive motors 42 including the at least some of the remaining rollers 44 to maintain the posture of the drive unit 30.

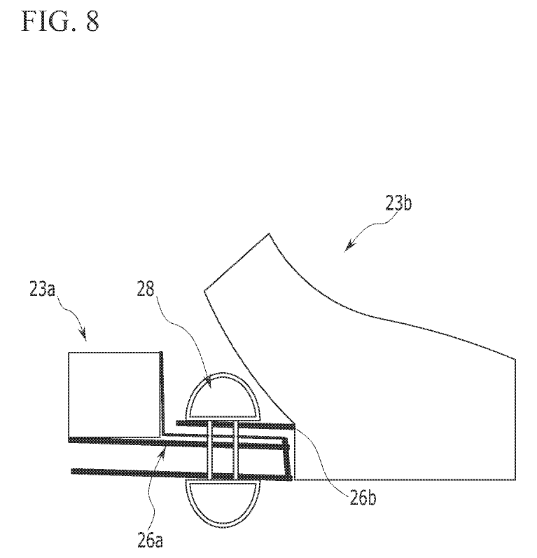

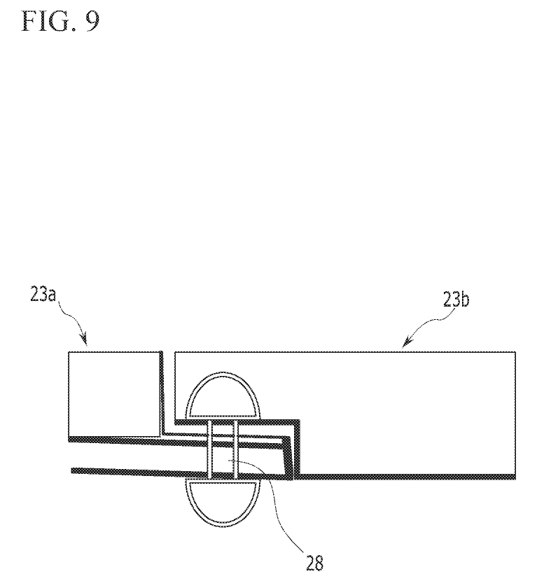

Hereinafter, a method of assembling the ball drive apparatus 20 according to an example embodiment of the present disclosure will be described with reference to FIGS. 8 and 9.

FIG. 8 is a schematic cross-sectional view along the line A-A of FIG. 2 of a ball drive apparatus before being assembled. FIG. 9 is a schematic cross-sectional view along the line A-A of FIG. 2 of a ball drive apparatus after being assembled.

As illustrated in FIG. 8, the ball drive apparatus 20 can include a plurality of ball pieces 23a and 23b. Each of the ball pieces 23a and 23b can include a ball housing piece and a tire piece at least partially attached to the ball housing piece. Each of the ball pieces 23a and 23b can have a shape corresponding to a partial portion of the outer circumferential surface of the spherical ball drive apparatus 20, and the outer appearance of the ball drive apparatus 20 can be formed when all of the ball pieces 23a and 23b are assembled.

Each ball housing piece can have a plate shape having an appropriate strength and a predetermined thickness. For example, the ball housing piece may be made of steel, aluminum, or an alloy thereof. Each ball housing piece can have the shape corresponding to the partial portion of the outer circumferential surface of the spherical ball housing 22, and the ball housing 22 can be manufactured when all of the ball housing pieces are assembled.

Each ball housing piece can include a protrusion 26a or 26b protruding toward another ball housing piece disposed adjacent thereto. For example, the first ball housing piece can include a first protrusion 26a protruding toward the second ball housing piece adjacent thereto, and the second ball housing piece can include a second protrusion 26b protruding toward the first ball housing piece adjacent thereto.

To assemble the ball drive apparatus 20, the plurality of ball pieces 23a and 23b can be arranged to surround the drive unit 30 with the drive unit 30 placed at the center as illustrated in FIG. 8. At such time, the first protrusion 26a and the second protrusion 26b can overlap each other, and no tire piece is attached to the second protrusion 26b. In such state, the first and second protrusions 26a and 26b overlapping each other can be joined together by a joining member 28. Here, the joining member 28 may be a screw, a bolt, a rivet, a pin, a weld, an adhesive, or the like, but is not necessarily limited thereto.

When the first and second protrusions 26a and 26b overlapping each other are joined together through the joining member 28, the tire piece can be attached to the second protrusion 26b to complete the assembling of the ball drive apparatus 20 as illustrated in FIG. 9.

In FIGS. 8 and 9, one example method of assembling the ball drive apparatus 20 is disclosed. However, the method of assembling the ball drive apparatus 20 is not necessarily limited thereto. For example, a plurality of ball housing pieces can be arranged to surround the drive unit 30 with the drive unit 30 placed at the center. At such time, the first protrusion 26a and the second protrusion 26b can overlap each other. In such state, the first and second protrusions 26a and 26b overlapping each other can be joined together by the joining member 28 to manufacture the ball housing 22. Thereafter, the tire 24 may be attached to the outer circumferential surface of the ball housing 22 to complete the assembling of the ball drive apparatus 20.

Although example embodiments of the present disclosure have been described above, the present disclosure is not necessarily limited to the above-described example embodiments, and includes all changes that can be easily made from the example embodiments of the present disclosure by those skilled in the art to which the present disclosure pertains within equivalent ranges.

What is claimed is:

1. A ball drive apparatus rotatably provided on a body of a mobility and configured to drive the mobility, the ball drive apparatus comprising:
a ball housing formed in a hollow spherical shape;
a tire attached to an outer circumferential surface of the ball housing; and
a drive unit provided inside the ball housing, wherein the drive unit includes at least one roller that contacts an inner circumferential surface of the ball housing to rotate the ball housing.

2. The apparatus of claim 1, wherein the at least one roller includes a plurality of rollers, and wherein the plurality of rollers are arranged so that a geometric center of the plurality of rollers coincides with a center of the ball housing.

3. The apparatus of claim 1, wherein the drive unit further comprises:
an integrated housing including a leg extending from a center of the ball housing toward the at least one roller;
a steering motor mounted at an end of the leg of the integrated housing and configured to rotate a motor shaft about the leg;
a mounting bracket connected to the motor shaft; and
a drive motor mounted on the mounting bracket and configured to rotate a drive motor shaft on which the at least one roller is mounted.

4. The apparatus of claim 3, wherein the drive motor shaft is perpendicular to the motor shaft of the steering motor.

5. The apparatus of claim 3, wherein the mobility includes a main battery provided in the body, and wherein the mobility includes a transmission coil electrically connected to the main battery, and wherein the drive unit further includes a reception coil mounted on the integrated housing in proximity to the transmission coil, and wherein the drive unit is configured to receive electric energy of the main battery from the transmission coil using a wireless charging method.

6. The apparatus of claim 5, wherein the drive unit further includes an auxiliary battery electrically connected to the reception coil, wherein the auxiliary battery is configured to receive the electric energy of the main battery transmitted to the reception coil from the transmission coil, wherein the auxiliary battery is electrically connected to one of or both of the steering motor and the drive motor, and wherein the auxiliary battery is configured to supply the electric energy to the one of or both of the steering motor and the drive motor.

7. The apparatus of claim 6, wherein the drive unit further includes a controller provided at the integrated housing and configured to control an operation of the drive unit.

8. The apparatus of claim 5, wherein the wireless charging method is one of or any combination of a magnetic resonance method, a magnetic induction method, and an electromagnetic wave method.

9. The apparatus of claim 8, wherein the wireless charging method is set according to a distance between the transmission coil and the reception coil.

10. The apparatus of claim 9, wherein, if the distance between the transmission coil and the reception coil is smaller than a first distance, the wireless charging method is the magnetic induction method, and if the distance between the transmission coil and the reception coil is greater than or equal to the first distance, the wireless charging method is the magnetic resonance method or the electromagnetic wave method.

11. The apparatus of claim 1, wherein the ball drive apparatus includes a plurality of ball pieces,
wherein the ball housing and the tire are manufactured by assembling the plurality of ball pieces, wherein a first ball piece of the plurality of ball pieces includes a first protrusion protruding toward a second ball piece of the plurality of ball pieces disposed adjacent to the first ball piece with no tire attached to the first ball piece, and
wherein the first protrusion of the first ball piece and a second protrusion of the second ball piece are overlapped and joined by a joining member, and wherein the tire is attached to the second protrusion.

12. A mobility comprising:
a body; and
a ball drive apparatus rotatably provided on the body, wherein the ball drive apparatus is configured to drive the mobility, and wherein the ball drive apparatus comprises:
a ball housing formed in a hollow spherical shape,
a tire attached to an outer circumferential surface of the ball housing, and
a drive unit provided inside the ball housing, wherein the drive unit comprises at least one roller that contacts an inner circumferential surface of the ball housing to rotate the ball housing.

13. The mobility of claim 12, wherein the drive unit of the ball drive apparatus further comprises:
an integrated housing including a leg extending from a center of the ball housing toward the at least one roller;
a steering motor mounted at an end of the leg of the integrated housing and configured to rotate a motor shaft about the leg;
a mounting bracket connected to the motor shaft; and
a drive motor mounted on the mounting bracket and configured to rotate a drive motor shaft on which the at least one roller is mounted.

14. The mobility of claim 13, further comprising:
a main battery provided in the body; and
a transmission coil electrically connected to the main battery and configured to transmit electric energy of the main battery to the drive unit using a wireless charging method,
wherein the drive unit further comprises a reception coil mounted on the integrated housing in proximity to the transmission coil, and wherein the reception coil is configured to receive the electric energy of the main battery from the transmission coil using the wireless charging method.

15. The mobility of claim 14, wherein the wireless charging method is one of or any combination of a magnetic resonance method, a magnetic induction method, and an electromagnetic wave method.

16. The mobility of claim 15, wherein the wireless charging method is set according to a distance between the transmission coil and the reception coil.

17. The mobility of claim 16, wherein, if the distance between the transmission coil and the reception coil is smaller than a first distance, the wireless charging method is the magnetic induction method, and if the distance between the transmission coil and the reception coil is greater than or equal to the first distance, the wireless charging method is the magnetic resonance method or the electromagnetic wave method.

18. The mobility of claim 14, wherein the drive unit further comprises an auxiliary battery electrically connected to the reception coil, wherein the auxiliary battery is configured to receive the electric energy of the main battery transmitted to the reception coil through the transmission coil, wherein the auxiliary battery is electrically connected to one of or both of the steering motor and the drive motor, and wherein the auxiliary battery is configured to supply the electric energy to the one of or both of the steering motor and the drive motor.

19. The mobility of claim 18, further comprising a control device provided in the body and configured to control operation of the mobility,
wherein the drive unit further comprises a controller provided at the integrated housing and configured to control operation of the drive unit, and
wherein the control device of the mobility and the controller of the drive unit are connected to each other in a wirelessly communicable manner.

20. A mobility comprising:
a body;
a ball drive apparatus rotatably coupled to the body such that the ball drive apparatus is configured to drive the mobility, and wherein the ball drive apparatus comprises:
a ball housing formed in a hollow spherical shape,
a tire attached to an outer circumferential surface of the ball housing, and
a drive unit provided inside the ball housing, wherein the drive unit comprises:
an integrated housing including four legs extending from a center of the ball housing toward the ball housing and distributed symmetrically about the center,
wherein for each of the four legs, the drive unit comprises a steering motor mounted at an end of each of respective leg of the four legs and configured to rotate a motor shaft about the respective leg,
wherein for each of the four legs, the drive unit comprises a mounting bracket connected to the motor shaft; and
wherein for each of the four legs, the drive unit comprises a drive motor mounted on the mounting bracket and configured to rotate a drive motor shaft on which at least one roller is mounted, wherein the at least one roller is in contact with an interior surface of the ball housing,
a reception coil mounted on the integrated housing,
an auxiliary battery electrically connected to the reception coil, wherein the auxiliary battery is electrically connected to each of the steering motor and the drive motor, and
a controller provided at the integrated housing and electrically connected to the auxiliary battery, wherein the controller is configured to control operation of the drive unit;
a main battery provided in the body;
a transmission coil provided in the body and electrically connected to the main battery, wherein the transmission coil is configured to transmit electric energy of the main battery to the auxiliary battery of the drive unit via the reception coil using a wireless charging method, wherein the auxiliary battery is configured to supply the electric energy to each of the steering motor and the drive motor; and
a control device provided in the body and configured to control operation of the mobility, wherein the control device of the mobility and the controller of the drive unit are configured to wirelessly communicate with each other.
